(19) United States
(12) Patent Application Publication
(10) Pub. No.: US 2008/0187236 A1
(43) Pub. Date: Aug. 7, 2008

(54) Image Contrast and Sharpness Enhancement

(75) Inventor: Henricus Wilhelm Peter Van Der Heijden, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/816,757

(22) PCT Filed: Mar. 1, 2006
(86) PCT No.: PCT/IB2006/050630

§ 371 Date: Aug. 21, 2007

(30) Foreign Application Priority Data
Mar. 3, 2005 (EP) 05101656.6

(51) Int. Cl. G06K 9/40

(52) U.S. Cl. 382/263

(57) ABSTRACT

The invention relates to a method for image enhancement. Overshoots of image boosting in areas with edges can be prevented by splitting an image into at least three sub-images, wherein each of the sub-images represents a corresponding spatial frequency range of the image, calculating a pixel detail signal for at least one of the sub-images, depending on at least a pixel detail signal of another frequency range, calculating a pixel change value for pixels within the sub-images depending on the corresponding pixel detail signal, calculating changed sub-images by changing pixel values within the sub-images depending on the corresponding pixel change value, and combining the changed sub-images into an output image.

The disclosure relates in general to changing pixel values within images, for instance, still images or video images.

From current applications, image enhancement by using local contrast boosting or other algorithms is known. For instance, the image content can be enhanced by “boosting” the image features, e.g. the pixel values on all frequencies of the spatial spectrum except the lowest frequency. A wide variety of techniques for processing and filtering signals, for instance, representing two-dimensional images, for example, still image or video images, have been developed. The clarity, contrast, and sharpness of images might be required to be improved due to transmission noise or other factors. It may also happen that the original image itself is insufficiently clear and needs to be sharpened.

A blurred or perceptually blurred image may be enhanced by enhancing high frequency spatial components of the image. For example, high frequency components are usually degraded more significantly during transmission than lower frequency components. Hence, enhancement of high frequency components may be effective in compensating for high frequency components lost during transmission. Insofar, image processing techniques modifying or supplementing the high spatial frequency components of an image have been developed.

One possible example for enhancing images, for example mentioned in U.S. Pat. No. 5,717,789, is the Burt-pyramid algorithm, permitting to synthesise an original high-resolution image from component sub-spectra images without the introduction of spurious spatial frequencies due to aliasing. The Burt-pyramid algorithm allows splitting the original image into a plurality of sub-images, with a hierarchy of separate component images. Each of the sub-images can be a laplacian image comprised of different spatial frequency ranges of the original image plus a remnant Gaussian image.

Boosting can result in changing the pixel values within the corresponding frequency ranges. An original image G₀ can be enhanced into an enhanced image G₀′ with

G₀′=g₀D₀+g₁D₁+g₂D₂+ . . . +gₙ₋₁Dₙ₋₁+Gₙ,

with gₙ≧1, g the pixel change value, and Dₙ the sub-images or derived sub-images in corresponding spectral frequency ranges of the original image. Dₙ can be understood as a set of sub-image derived from “primary” sub-images Gₙ. In the context of the disclosure, both Dₙ and Gₙ can be understood as sub-images, whereby Dₙ are derived from Gₙ, as will be described in more detail below. In contrast to sharpening techniques, which typically only work on the highest spatial frequencies, representing edges, the described boosting of pixel values in all frequencies, but the lowest frequency range can enhance both sharpness and contrast in smooth image areas, with little contrast.

However, changing the pixel values within all frequency ranges, regardless of image content, may result in overshoots, boosting pixel values in areas with edges higher than desired, resulting in poor image quality. In areas with low contrast, the enhancement may result in an image improvement, but areas with high contrast and edges may be changed such that they cause a “light emission” effect, with pixel values too high in certain areas to have an image improvement. In areas neighbouring edges, the pixel values may be boosted too much, causing these pixel to appear too bright.

Therefore, it is an object of the invention to provide an image enhancement which takes into account different contrast in different image areas. Another object of the invention is to provide image enhancement changing pixel values only where necessary. A further object of the invention is to provide image enhancement, where pixel change values of higher frequency ranges are taken into account when calculating pixel change values in lower frequency ranges. Yet another object of the invention is to reduce the “light emission” effect of local contrast boosting techniques.

These and other objects are solved, according to embodiments, with a method for changing pixel values within images with splitting an image into at least three sub-images, wherein each of the sub-images represents a corresponding spatial frequency range of the image, calculating a pixel detail signal for at least one of the sub-images, depending on at least a pixel detail signal of another frequency range, calculating a pixel change value for pixels within the sub-images depending on the corresponding pixel detail signal, calculating changed sub-images by changing pixel values within the sub-images depending on the corresponding pixel change value, and combining the changed sub-images into an output image.

The sub-images can, for example, be produced by convolving and decimating using a convolution filter. The convolution filter can be an FIR filter. Enhancing, for example, 5×5 or 7×7 pixel image segments with a separable FIR filter with 1d coefficients is possible. The filter coefficients can, for example, be (1, 4, 6, 4, 1)/16 or (1, 6, 15, 20, 15, 6, 1)/64. The output of such a filter can be fed back to the input, for example, after being down-sampled both horizontally and vertically with a factor of two. For example, an original 256×256 image gives rise to a 128×128 filtered and down-sampled image, than a 64×64 image etc. The output of the FIR filter can be fed back to its input, resulting in a sequence of images with less contrast due to a reduced amount of high frequency components.

According to embodiments, the sub-images can represent separate component images of the original image in corresponding spatial frequency ranges. For each of the sub-images a pixel detail signal depending on at least a pixel detail signal of a sub-image in another frequency range can be calculated. This allows creating pixel detail signals which account for pixel detail already detected in sub-images of a higher frequency. Thus, boosting of pixels in higher frequencies can already be accounted for.

A pixel change value enabling to change the pixel values in the respective frequency ranges can be calculated from the corresponding pixel detail signal. With the pixel change value, the values of the pixels in corresponding frequency ranges, e.g., the corresponding sub-images, can be changed. The changed sub-images can be combined into an output image with enhanced sharpness and contrast characteristics.

According to one embodiment, the pixel detail signal can be a cumulative pixel detail signal depending on at least a pixel detail signal of a neighbouring frequency range. For example, when calculating the pixel detail signal, a loop can be created to input the pixel detail signal of a higher frequency for calculating the pixel detail signal of the next frequency range. This allows accounting for detected pixel detail in a higher frequency range.

When calculating the pixel detail signal, embodiments can comprise calculating a maximum pixel value within an aperture of K×L pixels of a pixel detail signal within another frequency range, the aperture surrounding the corresponding pixel. K and L can denote integers. For example, the aperture can represent a 5×5 pixel filter. In an area of 5×5 pixels around the respective pixels in the pixel detail signal of the previous frequency range, the maximum value can be obtained.

Since each lower frequency has a larger working area, the pixel detail signal from a higher frequency band must be accumulated to this working area using a function that spreads the value over a similar larger area. For example, the pixel detail signal is up-sampled before calculating the maximum pixel value. Up-sampling can be carried out by increasing the number of pixels with a factor, for example 2, by interpolating.

To account for calculating the pixel detail signal in the corresponding frequency range after having calculated the maximum pixel value with an up-sampled pixel detail signal, embodiments can provide down-sampling the pixel detail signal after calculating the maximum pixel value. The down-sampling can be in the same amount as the previous up-sampling.

To account for boosting pixel values in higher frequencies, embodiments can provide calculating the pixel change value comprising decreasing the pixel change value with an increased cumulative pixel detail signal. The pixel detail signal accounts for the pixel change value.

According to embodiments, the pixel change value is calculated as

$${g}_{i} = 1 + ( f - 1 ) MAX ( \frac{T - {CATS}_{i}}{T} , 0 )$$

with g the pixel change value, f a gain factor, T a threshold value, CATS the pixel detail signal, and i an integer representing the corresponding frequency range. The MAX ( ) results in the maximum value between

$$\frac{T - {CATS}_{i}}{T}$$

and 0, thus having only positive values. If the CATS value is zero, i.e. no cumulative pixel detail signal has been detected, yet, the frequency band can be boosted with the full gain factor f. With an increasing CATS, the gain is transited to 1, which is reached when the CATS value exceeds the threshold value T. A global gain factor f can, for instance, be between 2 and 3. The threshold value can typically be around 64.

A derived sub-image can be calculated, according to embodiments, for at least one of the at least three sub-images. The derived sub-images can, for instance, be Differential of Gaussian (DOGS) images. The sub-images can be subtracted from the sub-image of the next higher frequency range, producing the Differential of Gaussian image.

According to one embodiment, the pixel detail signal can be calculated as CATSᵢ=abs Dᵢ (x,y)+max CATSᵢ₋₁. The maximum pixel value (max) of the pixel detail signal (CATS) of a higher frequency range can be added to the absolute value of a derived sub-image (D) obtaining the pixel detail signal (CATS) of the corresponding frequency range. The integer i can denote the corresponding frequency range.

According to embodiments, the pixel detail signal for the highest frequency range is the absolute value of the first derived sub-image. This accounts for that for the highest frequency range there is no pixel detail signal of a higher frequency range to be used as input for calculating the pixel detail signal.

Embodiments can provide splitting the image into at least three sub-images, comprising applying at least a spatial low-pass filtering, iteratively. The spatial low-pass filtering can be an FIR filter. The output of the low-pass filter can be fed back to the input to obtain an iteration of low-pass filtering.

Embodiments can provide down-sampling the low-pass filtered image after low-pass filtering. In case the down-sampled sub-images are used for calculating the derived sub-images, these are interpolated to allow subtracting the sub-image from the sub-image of the next higher frequency range.

Embodiments can provide combining the changed sub-images into an output image by calculating a summed value of the changed sub-images and the sub-image in the lowest frequency range. This can be done, for example, by calculating

$${G}_{0}^{′} ( x , y ) = {G}_{N} ( x , y ) + {\sum }_{i = 0}^{N - 1} {g}_{i} {D}_{i} ( x , y )$$

with G₀′ the output image, G_{N} the sub-image in the lowest frequency range and gᵢ the pixel change value and Dᵢ the derived sub-image. N denoting the absolute number of sub-images and i denoting the corresponding frequency range.

This calculation of the enhanced output image by adding the boosted values of the derived sub-images with the pixel change value involves interpolating the pixels in different grids. The derived sub-images of the frequency range i have a grid of M/2ⁱ×N/2ⁱ, thus, the derived sub-images need to be up-sampled before being summed-up.

Another aspect of the invention is an image enhancement device comprising first filter means arranged for splitting an image into at least three sub-images, wherein each of the sub-images represents a corresponding spatial frequency range of the image, first combination means arranged for calculating a pixel detail signal for at least one of the sub-images, depending on at least a pixel detail signal of another frequency range, second combination means arranged for calculating a pixel change value for pixels within the sub-images depending on the corresponding pixel detail signal, calculation means arranged for calculating changed sub-images by changing pixel values within the sub-images depending on the corresponding pixel change value, and third combination means arranged for combining the changed sub-images into an output image.

A further aspect of the invention is a computer program product tangibly embodied in an information carrier, the computer program product comprising instructions that, when executed, cause at least one processor to perform operations comprising: splitting an image into at least three sub-images, wherein each of the sub-images represents a corresponding spatial frequency range of the image, calculating a pixel detail signal for at least one of the sub-images, depending on at least a pixel detail signal of another frequency range, calculating a pixel change value for pixels within the sub-images depending on the corresponding pixel detail signal, calculating changed sub-images by changing pixel values within the sub-images depending on the corresponding pixel change value, and combining the changed sub-images into an output image.

Yet, a further aspect of the invention is a use of such a method in image processing and video processing.

These and other aspects of the invention will be apparent from and elucidated with reference to the following Figures.

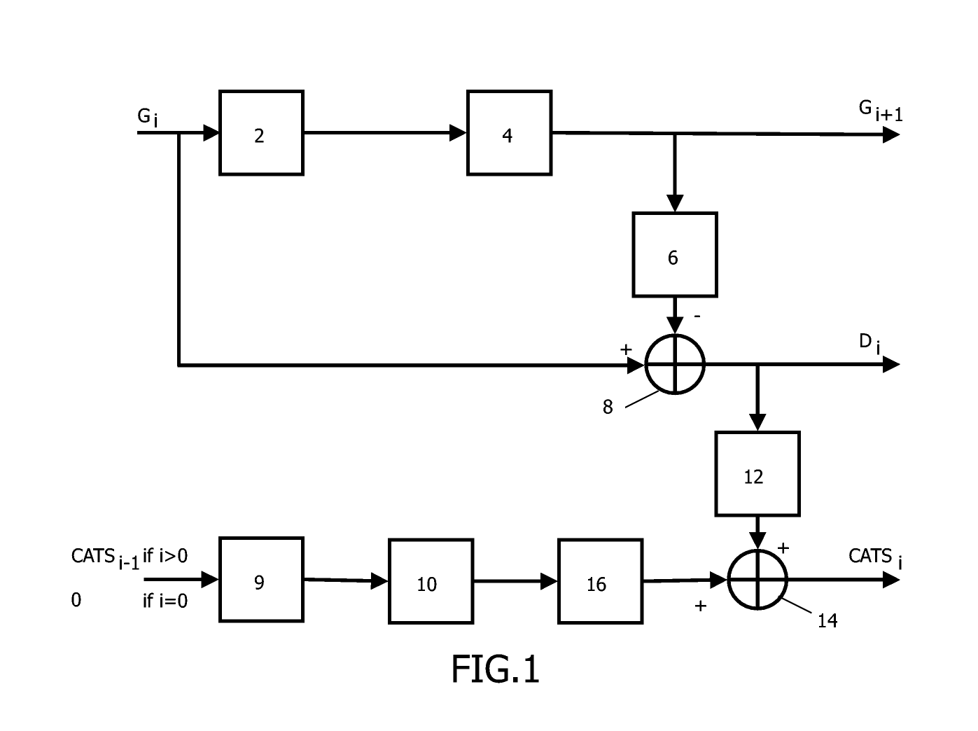

FIG. 1 illustrates a block diagram for obtaining sub-images, derived sub-images, and pixel detail signals;

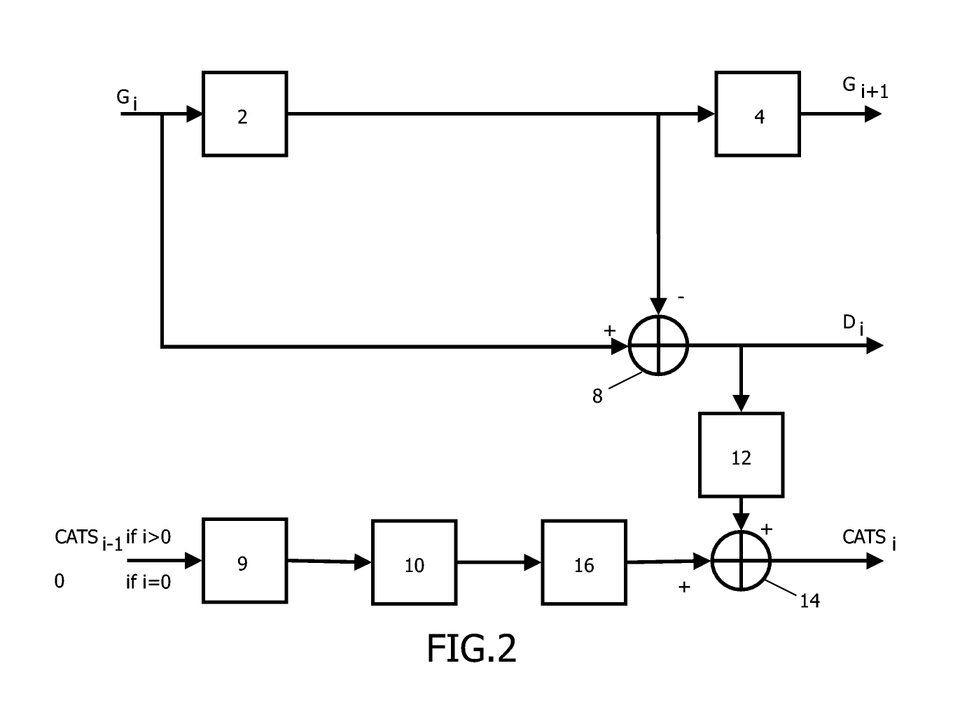

FIG. 2 illustrates a block diagram of a further embodiment;

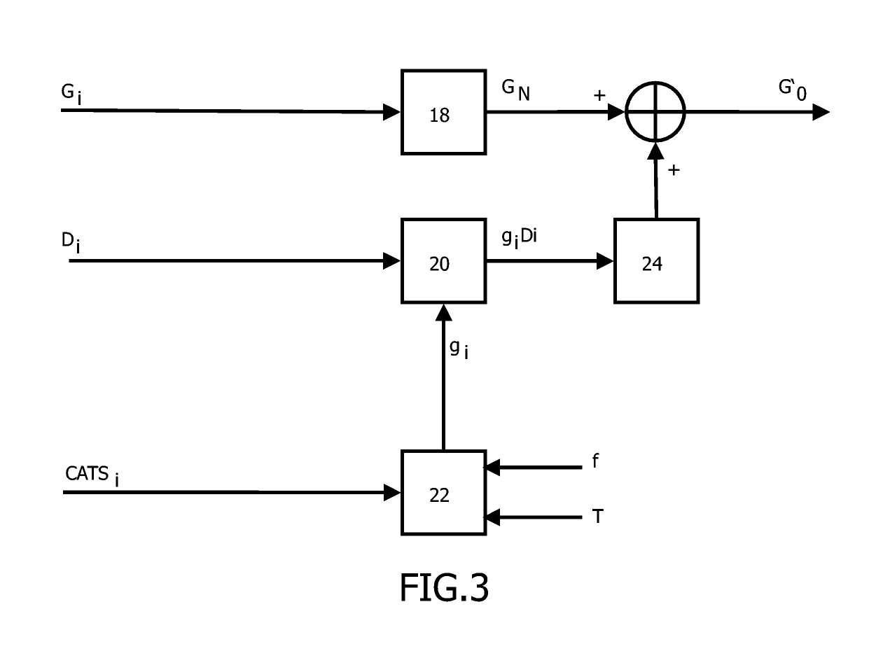

FIG. 3 illustrates a combination of pixel detail values, derived sub-images and sub-images into an output image, according to embodiments.

FIG. 1 illustrates a block diagram of a method for obtaining an enhanced image. Within FIGS. 1-3, G denote sub-images, i denotes the respective frequency range, G₀ denotes an original image. D represents derived sub-images. CATS denotes a pixel detail signal. g denote pixel change values and gD changed sub-images.

An input image G₀ is input to a Gaussian low-pass filter 2. The Gaussian low-pass filter 2 can be an FIR filter. The input of Gaussian low-pass filter 2 is convolved with a filter function obtaining a low-pass filtered sub-image. The pixel range of this image is M×N, with M and N integers denoting the size of a pixel range. The output of Gaussian low-pass filter 2 is input to a filter 4 for reducing the number of samples in the vertical and horizontal direction. The filter factor of filter 4 can, for instance, be 2. The output sub-image has M/2×N/2 samples. This sub-image is input for the next iteration of this algorithm in a feedback loop (not shown). By that, different sub-images can be obtained, with different numbers of samples and within different frequency ranges. For example, with G₀ having M×N samples, G₁ having M/2×N/2 samples, G₂ having M/4×N/4 samples, and G₃ having M/8×N/8 samples, etc.

Each sub-image is fed to interpolator 6, where the number of samples is increased by a respective factor. When the samples are reduced by a factor of 2 in filter 4, the samples are interpolated in interpolator 6 to obtain an image with two times the number of samples. The output of interpolator 6 is fed to subtractor 8. In subtractor 8, the sub-image is subtracted from the image in the next higher frequency range. In the first iteration, this is the input image G₀ subtracted by the first sub-image G₁, in the second iteration this is G₁, subtracted by the sub-image G₂, etc. The output of subtractor 8 is derived sub-image D in the respective frequency ranges i.

As illustrated in FIG. 2, the subtractor can also be arranged such that the output of Gaussian low-pass filter 2 is subtracted directly from the input image Gᵢ. This would allow omitting the interpolator 6. All other elements are the same as in FIG. 1. In this case, filter 4 can be arranged after the branch to subtractor 8.

Filter 12 provides obtaining the absolute value of the corresponding derived sub-image.

To obtain a pixel detail signal CATSᵢ a maximum filter 10 is fed by a pixel detail signal of a previous frequency range CATSᵢ₋₁. The pixel detail signal of the previous frequency CATSᵢ₋₁ can first be applied to an upsampling filter 9 to account for the different aperture in image segments of different frequency ranges. For the first iteration with i=0, the input to the maximum filter 10 is 0, and thus, the CATS₀ value is set equal to the absolute value of the derived sub-image D₀, which is added to the CATSᵢ signal through filter 12 in adder 14.

For each subsequent iteration, the pixel detail signal of the previous frequency range CATSᵢ₋₁ is passed through the maximum filter 10 with an K×L aperture. The K×L aperture, which can be a 5×5 aperture, allows finding the maximum pixel value in the vicinity of 5×5 pixel of the corresponding pixel in the input signal. In filter 10 the value of the pixel detail signal CATSᵢ in the corresponding frequency range is set to the maximum value of the pixel detail signal CATSᵢ₋₁ in the next higher frequency range in a 5×5 neighborhood around the pixel at position x, y. After that, the CATSᵢ signal output from maximum filter 10 is down-sampled in filter 16 and fed to adder 14. In adder 14, the CATSᵢ signal is added with the absolute value of the derived sub-image in the corresponding frequency range. Having obtained the pixel detail signal for each of the frequency bands, this signal can be used to obtain a pixel change value. the pixel change value can be calculated such that the higher the pixel detail signal is, the lower the pixel change value is.

From FIG. 3, the creation of pixel change values gᵢ, changed sub-images gᵢDᵢ and the creation of an output image G′₀ can be seen.

The pixel detail signal CATS can be a cumulative signal, taking into account the maximum value of the pixel detail signal in the neighbouring frequency range. Thus, a pixel detail signal CATS is increased during each iteration with the maximum value around corresponding pixels of the pixel detail signal of a previous frequency range.

Taking the pixel detail signal CATSᵢ for each frequency range i as an input, and having further an input of a gain value f and a threshold value T, the pixel change value can be calculated within combination means 22 as

$${g}_{i} = 1 + ( f - 1 ) MAX ( \frac{T - {CATS}_{i}}{T} , 0 )$$

Using this pixel change value gᵢ within the frequency ranges i, the calculator 20 can multiply the derived sub images Dᵢ within the respective frequency ranges to obtain the changed derived sub-images gᵢDᵢ. The derived sub-images Dᵢ are multiplied with the pixel change values gᵢ for each frequency range i in the calculator 20.

The changed derived sub-images gᵢDᵢ can be fed to summer 24, where a sum over all changed derived sub-images gᵢDᵢ is created within all frequency ranges i except the lowest frequency range denoted by N.

With the sum of gᵢDᵢ over i=0 to N−1, the enhanced output image G′₀ can be calculated as

$${G}_{0}^{′} ( x , y ) = {G}_{N} ( x , y ) + {\sum }_{i = 0}^{N - 1} {g}_{i} {D}_{i} ( x , y ) = {G}_{N} ( x , y ) + {\sum }_{i = 0}^{N - 1} 1 + ( f - 1 ) MAX ( \frac{T - {CATS}_{i} ( x , y )}{T} , 0 ) {D}_{i} ( x , y )$$

within adder 24. To obtain the last sub image G_{N}, a hold element 18 can be provided, only feeding the lowest frequency sub image G_{N} to the adder 24.

In order to obtain the output image, the derived sub-images are up-scaled to the original resolution, as necessary. The up-scaling can be linearly or bilinear, bicubic, or any other interpolation mechanism.

The calculation of the pixel change value has the effect that the frequency boosting is reduced for lower frequencies once the respective areas have been boosted already by a pixel change value in a higher frequency range. If there is, at a given image position, a pixel detail signal, or a so-called activity, on a higher frequency range, for example, due to a hard edge, the following lower frequencies will no longer be boosted. Each frequency band contains the signal from the previous frequency range extended over a larger area plus the activity from the band itself. An area with, for example, edges, has a high pixel detail value from the start, reducing the boosting at all following frequencies.

The method can be applied to image enhancement in television sets or video processing software or any video equipment in general.

1. Method for changing pixel values within images with
splitting an image into at least three sub-images, wherein each of the sub-images represents a corresponding spatial frequency range of the image,
calculating a pixel detail signal for at least one of the sub-images, depending on at least a pixel detail signal of another frequency range,
calculating a pixel change value for pixels within the sub-images depending on the corresponding pixel detail signal,
calculating changed sub-images by changing pixel values within the sub-images depending on the corresponding pixel change value, and
combining the changed sub-images into an output image.

2. Method of claim 1, wherein calculating the pixel detail signal comprises calculating a cumulative pixel detail signal depending on at least a pixel detail signal of a neighbouring frequency range.

3. The method of claim 1, wherein calculating a pixel detail signal comprises calculating a maximum pixel value within an aperture of K×L pixels of a pixel detail signal within another frequency range, the aperture surrounding the corresponding pixel.

4. The method of claim 3, wherein the pixel detail signal is up-sampled before calculating the maximum pixel value.

5. The method of claim 3, further comprising down-sampling the pixel detail signal after calculating the maximum pixel value.

6. Method of claim 1, wherein calculating the pixel change value comprises decreasing the pixel change value with an increased cumulative pixel detail signal.

7. Method of claim 6, wherein calculating the pixel change value comprises calculating
$${g}_{i} = 1 + ( f - 1 ) MAX ( \frac{T - {CATS}_{i}}{T} , 0 )$$
with g the pixel change value, f a gain factor, T a threshold value, CATS the pixel detail signal, and i an integer representing the corresponding frequency range.

8. Method of claim 1, further comprising calculating derived sub-images for at least one of the at least three sub-images.

9. The method of claim 8, wherein calculating the derived sub-images comprises combining at least two sub-image within different frequency ranges.

10. The method of claim 8, wherein calculating the pixel detail signal as
CATSᵢ=abs Dᵢ(x,y)+max CATSᵢ₋₁
with CATS the pixel detail signal, D the derived sub-image, x, y pixel co-ordinates, and i an integer denoting the corresponding frequency range.

11. The method of claim 8, wherein the pixel detail signal for the highest frequency range is the absolute value of the first derived sub-image.

12. The method of claim 1, wherein splitting the image into at least three sub-images comprises applying at least a spatial low-pass filtering iteratively.

13. The method of claim 12, further comprising down-sampling the low-pass filtered image after low-pass filtering.

14. The method of claim 1, wherein combining the changed sub-images into an output image comprises calculating a summed value of the changed sub-images and the sub-image in the lowest frequency range.

15. The method of claim 1, wherein combining the changed sub-images into an output images comprises up-sampling the changed sub-images to the pixel grid of the input image.

16. Image enhancing device with
first filter means arranged for splitting an image into at least three sub-images, wherein each of the sub-images represents a corresponding spatial frequency range of the image,
first combination means arranged for calculating a pixel detail signal for at least one of the sub-images, depending on at least a pixel detail signal of another frequency range,
second combination means arranged for calculating a pixel change value for pixels within the sub-images depending on the corresponding pixel detail signal,
calculation means arranged for calculating changed sub-images by changing pixel values within the sub-images depending on the corresponding pixel change value, and
third combination means arranged for combining the changed sub-images into an output image.

17. A computer program product tangibly embodied in an information carrier, the computer program product comprising instructions that, when executed, cause at least one processor to perform operations comprising:
splitting an image into at least three sub-images, wherein each of the sub-images represents a corresponding spatial frequency range of the image,
calculating a pixel detail signal for at least one of the sub-images, depending on at least a pixel detail signal of another frequency range,
calculating a pixel change value for pixels within the sub-images depending on the corresponding pixel detail signal,
calculating changed sub-images by changing pixel values within the sub-images depending on the corresponding pixel change value, and
combining the changed sub-images into an output image.

18. Use of a method of claim 1 in image processing, video processing, television displays, computer displays.
